(19) United States
(12) Patent Application Publication
(10) Pub. No.: US 2006/0262104 A1
(43) Pub. Date: Nov. 23, 2006

(54) Systems and methods for distinguishing contact-induced plate vibrations from acoustic noise-induced plate vibrations

(76) Inventors: Darius M. Sullivan, Cambridge (GB); Nicholas P.R. Hill, Cambridge (GB); Vladimir P. Gontcharov, Cambridge (GB); Roger G. Geere, Cambridge (GB)

Correspondence Address: 3M INNOVATIVE PROPERTIES COMPANY, PO BOX 33427, ST. PAUL, MN, 55133-3427, US

(21) Appl. No.: 11/132,504

(22) Filed: May 19, 2005

(51) Int. Cl. G09G 5/00

(52) U.S. Cl. 345/177

(57) ABSTRACT

The present invention is directed to systems and methods of distinguishing acoustic noise from valid plate contacts in vibration sensitive devices such as vibration sensing touch panels. The energy content of the detected vibration spectrum can be analyzed for features characteristic of noise, for example a higher relative contribution from high frequencies due in part to preferential coupling of above coincidence frequencies over below coincidence frequencies.

The present invention relates to devices that utilize vibrations propagating through a plate due to a contact to obtain information related to the contact, for example a vibration sensing touch input device.

### BACKGROUND

Touch input devices can provide convenient and intuitive ways to interact with electronic systems including computers, mobile devices, point of sale and public information kiosks, entertainment and gaming machines, and so forth. Various touch input device technologies have been developed including capacitive, resistive, inductive, projected capacitive, surface acoustic wave, infrared, force, and others. It is also possible to form a touch input device from a touch plate provided with vibration sensors that detect vibrations propagating in the touch plate due to a touch input and determine the touch location from the detected vibrations.

### SUMMARY

The present invention provides a method that includes detecting vibrations propagating in a panel, developing a signal representative of the vibrations, generating an energy spectrum for the developed signal, and analyzing the energy spectrum for the presence of one or more features characteristic of ambient noise. From this analysis, noise signals can be distinguished from signals generated by valid panel contacts.

The present invention also provides a method for use with a vibration sensitive touch panel that includes the steps of characterizing a first feature set for energy spectra associated with panel vibrations caused by valid panel contacts, characterizing a second feature set different than the first for energy spectra associated with vibrations caused by noise, and comparing signals obtained from measured panel vibrations to the first feature set and the second feature set to determine whether the measured panel vibrations are indicative of a valid panel contact or a noise event.

Further, the present invention provides a vibration sensing touch panel system that includes vibration sensors coupled to a touch plate and configured to generate signals in response to vibrations propagating in the touch plate, and electronics in communication with the vibration sensors and configured to analyze an energy spectrum of the signals generated by the vibration sensors to determine the presence or absence of spectral features indicative of acoustic noise. The electronics can also be configured to determine contact location for signals determined not to originate from acoustic noise.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 schematically shows a vibration sensing touch input system.

FIG. 2 schematically shows an acoustic wave incident on a bending wave panel.

FIG. 3 schematically shows an acoustic noise event occurring proximate a vibration sensitive touch input device.

FIG. 4 schematically shows an arrangement of vibration transducers disposed on a vibration sensitive panel.

FIGS. 5(a) and 5(b) show the time domain and frequency domain, respectively, for detected vibrations caused by a noise event.

FIGS. 5(c) and 5(d) show the time domain and frequency domain, respectively, for detected vibrations caused by a valid touch contact.

FIGS. 6(a)-6(c) show a set of histograms indicating the number of measured occurrences of acoustic noise events that exhibit a particular spectral ratio p₁, a particular impulse ratio p₂, and a particular combination of p₁ and p₂.

FIGS. 7(a)-7(c) show a set of histograms indicating the number of measured occurrences of acoustic noise events that exhibit a particular spectral ratio p₁, a particular impulse ratio p₂, and a particular combination of p₁ and p₂.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

The present invention relates to systems and methods for distinguishing vibrations propagating in a panel due to contact with the panel from vibrations propagating in the panel due to ambient acoustic noise coupled into the panel. For example, vibrations sensing touch panels that determine touch position based on the vibrations caused by the contact of a touch input on the panel can be susceptible to false recording of a touch event due to spurious panel vibrations caused by noise.

The present invention can be advantageously applied to discern between an acoustically generated noise event and a valid touch contact on a vibration sensing touch panel. Methods and systems of the present invention can be used alone or in combination with impulse reconstruction or other noise detection methods for improved rejection of spurious points under some circumstances. Examples of other noise detection methods include using a separate microphone that is acoustically isolated from the panel to continuously monitor for ambient noise. Better discernment of spurious points through use of the present invention may also translate to less rejection of valid touches by impulse reconstruction or alternative touch point validation methods, and consequently improved effective sensitivity to light touches.

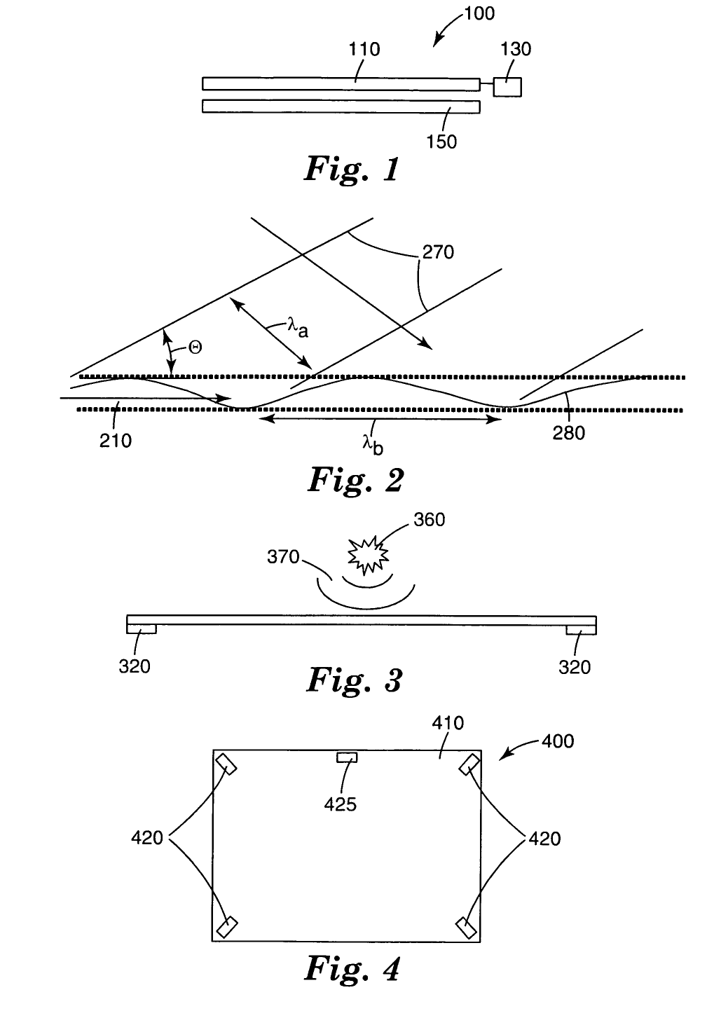

FIG. 1 schematically shows a vibration sensing touch input system 100 that includes vibration sensing touch panel 110 coupled to electronics 130 for determining information related to a touch input, such as touch position, touch implement type, etc., from signals generated by vibration transducers (not shown) coupled to the panel in response to vibrations propagating in the plate. Electronics 130 can also be used to detect and discern signals or signal characteristics that are indicative of noise or other vibration-inducing events that are not valid touches so that such signals or characteristics can be disregarded, subtracted from other signals, or otherwise accounted for. Optionally, panel 110 can be disposed proximate to a display device 150 such as an electronic display, static graphics, or combinations of the like, so that the display device 150 is viewable through the panel 110. In other embodiments, static or changeable images can be projected onto the panel 110 either from the front or from the back. In some embodiments it may be desirable to include graphics on the panel, for example printed on specified areas of a transparent panel, printed on an opaque panel, and so forth.

One mode of operation of a vibration sensing, or bending wave, touch panel is the input of energy by the contact of a touch implement such as a finger or stylus on the touch plate of the touch panel. Energy from the contact propagates in the form of bending waves from the contact point to a set of vibration sensors positioned in various locations on the touch plate, for example one in each of the corners of a rectangular plate. Each vibration sensor can be used to develop signals, and the signals can be cross-correlated to determine the position of the contact. A more accurate determination of contact position can be achieved by correcting for dispersion of the bending waves propagating in the touch plate. The following documents, each of which is incorporated by reference, disclose one or more of various vibration sensing touch panels, vibration sensing transducers and transducer arrangements, and methods to locate the contact, or determine other information related to the contact, based on analysis of the vibrations signals: EP1240617B1, WO2003005292, U.S. Pat. No. 6,871,149, and commonly assigned U.S. patent application Ser. Nos. 10/440,650, 10/683,342, 10/739,471, 10/750,291, 10/750,502, 10/750,290, 10/850,324, 10/850,516, 10/957,364, 10/957,234, 60/615,469, 11/025,389, 11/032,572, and 11/116,463.

In particular, a method referred to as “impulse reconstruction” has been disclosed in above-mentioned and incorporated U.S. Ser. No. 10/750,290. Impulse reconstruction can be used as a consistency check to verify the validity of a touch input point reported to the system. In this method, a scaling and phase factor can be applied to the signals from each transducer signal channel to reverse the effects of the propagation in the panel (e.g., dispersion), thereby “reconstructing” the original impulse that was created by the touch contact event. For example, given a determined touch location, preferably after removing dispersion effects, the signals received at each transducer can be time reversed back to the point of the original contact, thereby reconstructing the original impulse.

One use of impulse reconstruction is to distinguish between valid inputs, which result in similar reconstructed impulses from each sensing channel, and spurious points generated by noise events. Such noise events can include mechanical events such as contacts to the bezel of an integrated touch screen, which can couple vibrations into the touch plate through the supporting gasket, and acoustic events where ambient sound is incident on the touchscreen, generating bending waves in the panel. Both of these noise sources can generate transient signals in the panel that may incorrectly return a touch input location when the signals are analyzed by the location algorithm. The impulse reconstruction method helps to discern between a true contact location and a spurious noise-generated point. As discussed in this document, however, certain acoustic noise conditions may be difficult to discern using only impulse reconstruction. In at least these cases, methods and systems of the present invention can be used to discern true plate contact events from noise events.

The present invention involves analyzing the shape of the energy spectrum developed from signals detected by vibration sensing transducers in response to vibrations propagating in the touch plate. Methods of the present invention take advantage of the phenomenon that the vibrations generated in the touch plate due to typical acoustic noise events are distinguishable from those generated due to typical touch contact events. In particular, a touch contact to the panel generally creates greater low frequency energy content than does an acoustic noise event. While this is partially dictated by the typical frequency spectra of acoustic noise versus touch contact events, it is also caused by frequency dependent, or “microphonic,” coupling of the acoustic noise to the panel, which disfavors coupling of lower frequencies.

There are two distinct frequency bands over which the mechanism for microphonic pickup of acoustic vibrations by a panel differs, those frequencies that are less than the coincidence frequency, termed “below coincidence,” and those frequencies that greater than the coincidence frequency, termed “above coincidence.” The coincidence frequency is the frequency at which the speed of bending wave propagation in the panel is the same as that in the ambient medium, typically air, which will be assumed to be the ambient medium in this document without loss of generality. Below the coincidence frequency the bending wavespeed is less than that in air, whereas above the coincidence frequency the bending wavespeed is greater than that in air.

The coincidence frequency is a function of properties of the panel, including material and thickness. For 2 mm thick glass, a typical thickness for bending wave touch panels, the bending wave velocity is given by the following dispersion relation:
k=0.53×\sqrt{ω},
where ω is angular frequency and k is the wavevector of the bending wave, and 0.53 is a factor that folds in various physical properties of the panel. The wavevector relates to the bending wave velocity, v_{B}, by the following equation:

$${v}_{B} = \frac{ω}{k} .$$

The frequency at which the bending wave velocity equals the speed of sound in air (343 meters per second) is therefore 5.3 kHz.

For below coincidence frequencies, there is no direct matching between the sound wave in air and a bending wave in the panel. Any coupling of sound below coincidence is characterized by an approximately omni-directional response. For above coincidence frequencies, there can be a direct match between the waves in the air and vibrations in the panel and a directional response, as indicated by FIG. 2.

FIG. 2 shows ambient sound waves 270 (parallel straight lines indicate wavefronts with the direction of incidence indicated by the arrow) incident on a panel 210 at an angle Θ. λₐ is the wavelength of the ambient acoustic waves 270. Also shown is a bending wave 280 having wavelength λ_{b} propagating from left to right through the panel 210. The angle Θ at which the wavefront of sound wave 270 matches the wavefront of the bending wave 280 is related to the wavelengths according to the following equation:

$$sin ( Θ ) = \frac{{λ}_{a}}{{λ}_{b}} .$$

Microphonic pickup above coincidence (λₐ less than λ_{b}) is significantly more efficient than below coincidence (λₐ greater than λ_{b}), and has a directional response. At coincidence (λₐ equal to λ_{b}), the most efficient angle for microphonic pickup is along the plane of the panel (Θ=90°). As the frequency increases (and the panel bending wavespeed increases), the matching angle moves towards normal incidence (Θ=0°).

FIG. 3 depicts an ambient acoustic noise situation that can lead to erroneously registering a touch contact event. An acoustic source 360 produces a transient sound wave 370 that impinges upon panel 310. Panel 310 includes vibration transducers 320 that detect vibrations propagating in the panel. Examples of noise events that can cause registration of spurious points include hand claps, finger clicks or snaps, jangling keys, impacting two metal objects together, and so forth. Each of these noise events may create a different characteristic set of vibration frequencies propagating in the panel.

If the noise source 360 is relatively far away from the panel (e.g., on the scale of the panel size or more) then the wavefront 370 will be relatively spread out and flat by the time it reaches the panel. As such, there is likely no detectable single point of incidence, and any attempt to reconstruct an impulse based on a reported touch point would likely yield a spread out impulse, indicating a false touch event that can be ignored or cancelled. Furthermore, ambient sounds from noise sources far away from the panel and that are not centered on the panel will yield dissimilar signals between signal correlation channels associated with different transducer pairs. Comparing the reconstructed impulse to the impulse between channels and the sharpness of the impulse would likely reject these cases.

When the sound source 360 is relatively close to the panel 310 (e.g., within a distance smaller than the size of the panel), the situation can be more problematic for previously implemented solutions such as impulse reconstruction to address. In this case the sound 370 is likely to propagate out from the sound source 360 over the surface of the panel 310, resulting in stronger coupling into the panel 310 above the coincidence frequency. Such strong coupling may trigger the system to attempt to determine the location of what at first seems to be a touch contact, even for relatively weak sound sources. Furthermore, at and around the frequencies of this strong coupling, the speed of propagation of sound waves in the air is similar to the propagation speed in the panel, and as such the signals detected at each vibration sensing transducer 320 are similar to what would be detected when a touch contact to the panel 310 occurred at a location directly under the sound source 260. As a result, the impulse reconstruction method may interpret the noise as an approximate impulse event corresponding to a location under the sound source, thereby seeming to confirm a touch input rather than indicating a false touch due to noise.

In the present invention, it is recognized that coupled ambient acoustic noise has a characteristic energy spectrum distinct from the energy spectrum of touch contact events, even for cases in which the acoustic noise pickup events give rise to a signal that as a reconstructed impulse looks like a real touch and is erroneously not rejected. For acoustic noise coupled into a touch plate, a general rise in high frequency pickup over low frequencies would be expected due to more efficient pickup above coincidence. In addition, for sound sources that are relatively close to the panel and having a relatively smooth frequency output (i.e., not strongly peaked), the coupled vibrations would be expected to show a maximum for frequencies close to the panel coincidence frequency. For sound sources that are strongly peaked around a frequency band, as is often the case when like objects are struck together to generate the sound, a maximum near the coincidence frequency may not be readily observed.

The shape of the energy spectrum of detected noise-induced vibrations will also depend on the spectrum of the sound output from the noise source. In principle, the noise source could have a frequency response that is strongly weighted towards low frequencies, which in turn could compensate for the coincidence effect, yielding a more even spectral shape in the panel pickup signal. In such a case, however, the low frequency airborne sound would spread out from the contact point significantly faster in air than any induced bending wave in the panel. The likely end result is a signal that when reconstructed would yield a spread out impulse that would be recognized as a false touch by the impulse reconstruction algorithm and rejected. Observing a spectral characteristic of higher contribution from above coincidence frequencies and lower contribution from below coincidence frequencies is therefore likely to reveal spurious points generated by acoustic noise that are not likely to be rejected by the impulse reconstruction technique. Conversely, the cases in which the distinction between above and below coincidence frequencies is muted, the impulse reconstruction technique is likely to catch and reject the spurious point. As such, spectral shape methods can be combined in a complementary fashion with impulse reconstruction to better discern common noise events while better detecting valid contacts.

Once noise events are discerned, the spectral characteristics of the signal can be further analyzed to determine the type of noise event (e.g., hand clap, clinking of metal objects, etc.) in cases where it is desirable to do so. For example, the spectral content of the signal can be compared to various sample signals recorded during a calibration step.

When a true, or valid, contact occurs on the panel, the typical actions of the user and the implement used to contact the panel give rise to a wide and varied bandwidth of induced bending waves, typically including a high level of low frequency energy. Such low frequency energy contains relatively little useful location information because of the long spatial wavelength of the bending waves propagating in the panel at these frequencies, which tends to blur out spatial resolution. Indeed, when determining touch position, the low frequency energy is preferably filtered so as to emphasize the higher frequency energy, thereby reducing the dynamic range requirements on the signal chain. However, as discussed, detecting the low frequency vibrations can be useful in distinguishing valid touches from noise.

Signals detected from the valid contact, when processed through the location algorithm and impulse reconstruction, are expected to have a significantly greater level of low frequency energy than for ambient acoustic noise events (normalized for similar high frequency levels). The actual spectral shape of signals will also depend on the electronic and/or digital filtering in the signal chain. Even so, a true touch should be well characterized by an increased ratio of below coincidence energy to above coincidence energy. In one embodiment of the present invention, a threshold ratio of below coincidence energy to above coincidence energy can be used to distinguish true touches from acoustic noise, providing an improved touch sensor through enhanced rejection of acoustically generated spurious points.

The signals upon which measurements of the spectral shape are based can be one or both of: pickup from a separate sensor, for example a dedicated transducer optimized for pickup of low frequency energy (exemplary transducers include those disclosed in commonly assigned U.S. patent application Ser. Nos. 10/683,342 and 10/957,364, previously referred to and incorporated by reference); and pickup from the sensing channels that are optimised for contact location.

FIG. 4 schematically shows one embodiment of a vibration sensing touch panel 400 that includes a plurality of vibration sensitive transducers 420 coupled to a panel 410 for detecting bending wave vibrations propagating in the panel. Exemplary transducers and arrangements are disclosed in U.S. Ser. No. 10/739,471 and U.S. Ser. No. 10/440,650, previously referred to an incorporated by reference. An additional transducer 425 can optionally be included for added functionality, including any combination of one or more of:
1) Wake on touch (e.g., disclosed in U.S. Ser. No. 10/683,342, previously referred to and incorporated by reference). A voltage pulse can be generated by the additional piezoelectric transducer, which is provided without the field effect transistor (FET) circuit that is typically provided in the bending wave sensing transducer channels. This voltage pulse can be used to wake up the system from a sleep mode. The lack of a FET circuit on this transducer allows the system to be placed in a very low power mode without any FET amplifier remaining powered while still retaining the ability to be awakened.
2) Active lift off (e.g., disclosed in U.S. Ser. No. 10/957,364, previously referred to and incorporated by reference). A high frequency signal can be emitted by the additional piezoelectric transducer, creating a pattern of ultrasonic energy propagating in the panel (after undergoing multiple reflections in the plate). A touch to the panel can cause a change in this pattern, which can in turn be sensed by the receiving transducers. This change can be used to indicate a touch-down event, whereas a return to the original pickup signal can indicate a lift-off event.
3) Active location (e.g., disclosed in EP1240617B1, WO2003005292, and U.S. Ser. No. 10/750,502, previously referred to and incorporated by reference). The additional piezoelectric transducer can be used to generate a bending wave in the plate that interacts with a contact implement through reflection or absorption (and diffraction). The effect of the contact can be converted into, for example, a dispersion corrected impulse response, a dispersion corrected correlation function, etc., which can be used to obtain the contact location.
4) Passive lift-off (e.g., disclosed in U.S. Ser. No. 10/957,364, previously referred to and incorporated by reference). The additional piezoelectric transducer can be used to sense very low frequency signals, for example to detect positive or negative impulses that indicate touchdown or lift-off events. Alternatively, the presence of a contact on the panel may be indicated by a steady low frequency rumble sensed by the additional piezoelectric transducer, and which disappears when the contact is removed.
5) Auto-configuration (e.g., disclosed in U.S. Ser. No. 10/750,502, previously referred to and incorporated by reference). The additional piezoelectric transducer can be used to generate bending waves in the panel, which can in turn be picked up by the sensing transducers, possibly after one or more reflections. These signals may be used to determine the plate geometry for automatic setup of parameters, such as panel size, dispersion constant, etc., by the controller firmware.

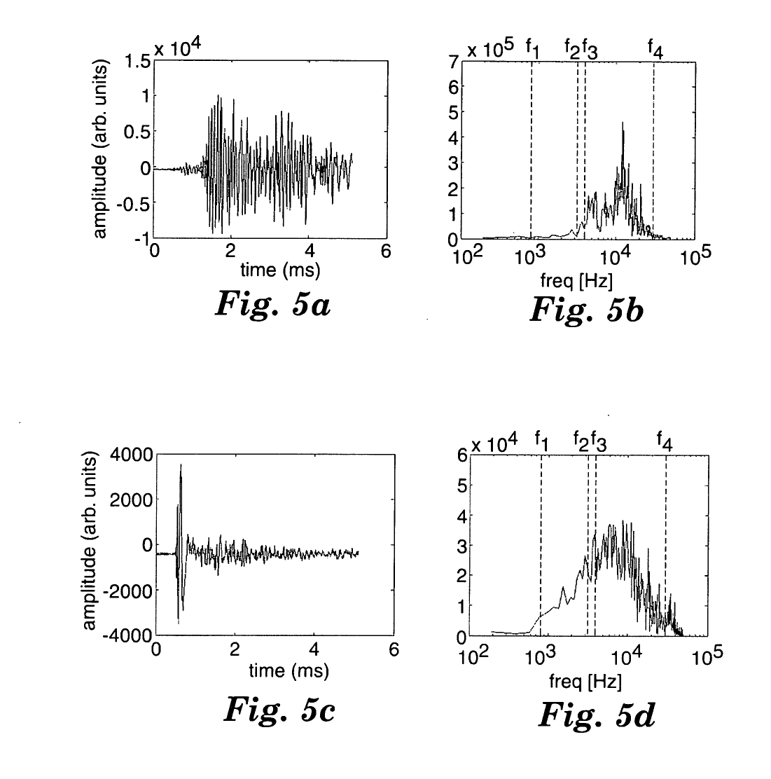

In a particular embodiment, whether detected signals derive from an acoustic noise source can be determined by calculating sums of the amplitudes in two ranges in the frequency domain, which can be illustrated in reference to FIG. 5. FIGS. 5(a) and 5(c) show raw time domain bending wave signals due to an acoustic noise source (5(a)) and a finger contact (5(c)) with a 2 mm thick glass panel. FIGS. 5(b) and 5(d) show the frequency domain for the signals shown in FIGS. 5(a) and 5(c), respectively. As shown in FIGS. 5(b) and 5(d), a first, low frequency domain ranges from frequency f, to frequency f₂, and a second, high frequency domain ranges from frequency f₃ to frequency f₄ (where f₁<f₂<f₃<f₄). The frequency ranges can be selected according to an analytical approach that takes into account the coincidence frequency, or can be based on a phenomenological approach that takes into account observed frequency ranges over which ambient noise transitions from being inefficiently coupled to efficiently coupled.

Amplitude sums of the signals over each of these frequency domains can be calculated, represented as S(f₁ . . . f₂) and S(f₃ . . . f₄). Then, by determining a parameter p₁ representing a ratio of the two sums, namely p₁=S(f₁ . . . f₂)/S(f₃ . . . f₄), it can be determined that the signals represented by FIGS. 5(a) and 5(b) includes more high frequency content than the signals represented by FIGS. 5(c) and 5(d). Further, it can be determined whether p₁ exceeds a threshold value, in this case the threshold value being set so that the signals represented by FIGS. 5(a) and 5(b) do not exceed the threshold, indicating acoustic noise, and the signals represented by FIGS. 5(c) and 5(d) exceed the threshold, indicating a potential valid touch input. This ratio and threshold approach can also be used in combination with other observations or measurements to make more accurate judgments and/or to further distinguish and filter noise events from valid touch events.

For example, if the frequency limits in FIG. 5 are set as: f₁=800 Hz, f₂₌₃₂₀₀ Hz, f₃₌₄₀₀₀ Hz, and f₄₌₃₀₀₀₀ Hz, the example acoustic signal in FIGS. 5(a) and 5(b) gives a value of p₁=0.014 and the example finger contact signal in FIGS. 5(c) and 5(d) gives a value of p₁=0.081. The threshold for valid contacts versus noise events can be set between these two values.

Additional parameters can optionally be folded into the analysis. For example, an additional parameter, p₂, can be obtained from impulse reconstruction algorithms, where p₂ represents a measure of the alignment of the reconstructed impulses for each of the signal channels, a higher degree of alignment indicating a higher likelihood of a impulse event, and therefore a valid contact.

For example, starting with a set of reconstructed impulses, one for each signal channel, an alignment function can be calculated for slices of time that range over an interval shorter than the duration spanned by the reconstructed impulse data. For each time slice, the minimum value of the reconstructed impulses across all the channels within that time slice is divided by the sum of the absolute values of the reconstructed impulses over all the channels and from the first sample up to the sample some interval below the time slice being evaluated (e.g., up to the sample 20 microseconds before the time slice being evaluated). Calculating the alignment function in this manner yields a sharp positive spike at the point where the reconstructed impulses best align, and highest magnitude of the spike is a measure of how well the reconstructed impulses are aligned. As such, the parameter p₂ can be defined as the maximum value of the alignment function over the interval calculated.

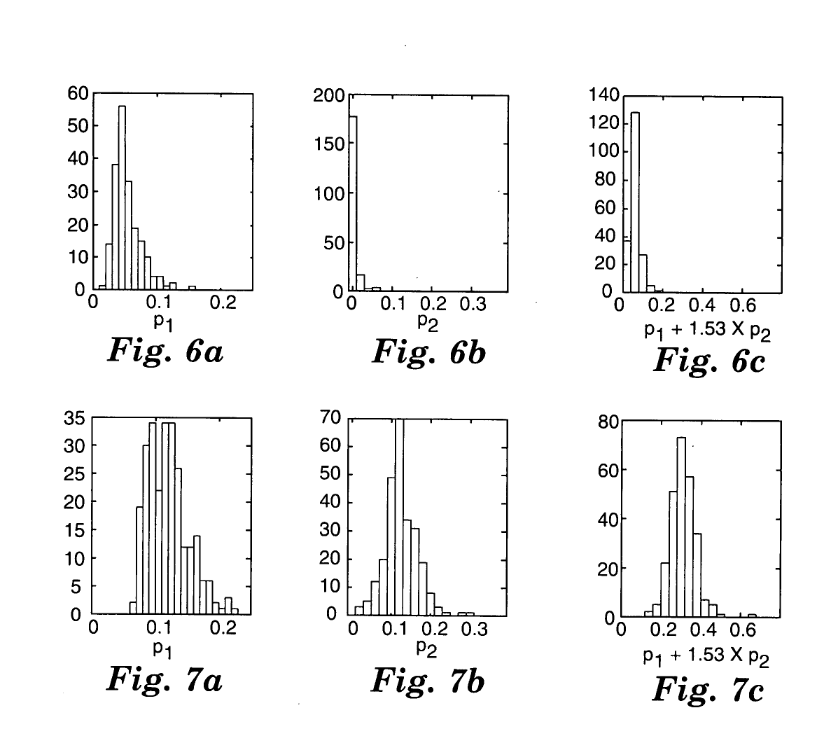

FIG. 6 shows a set of histograms indicating distributions of different parameters observed for a number of vibration signals caused by acoustic noise impinging on a 2 mm thick glass plate, FIG. 6(a) showing the number of occurrences of various values for p₁, FIG. 6(b) showing the number of occurrences of various values for p₂, and FIG. 6(c) showing the number of occurrences of various values for a weighted combination of p₁ and p₂, namely p₁+1.53×p₂, discussed below. Similarly, FIG. 7 shows a set of histograms indicating distributions of different parameters observed for a number of vibration signals caused by finger contacts on a 2 mm thick glass plate, FIG. 7(a) showing the number of occurrences of various values for p₁, FIG. 7(b) showing the number of occurrences of various values for p₂, and FIG. 7(c) showing the number of occurrences of various values for a weighted combination of p₁ and p₂, namely p₁+1.53×p₂. The particular weighted combination was chosen based on the results for parameters p₁ and p₂ to provide a minimal amount of overlap between the acoustic noise and finger contact distributions. Given the selected formula of p₁+1.53×p₂, a threshold, τ, can then be defined such that only finger contacts satisfy the condition p₁+1.53×p₂>τ, and substantially all similar acoustic noise events satisfy the condition p₁+1.53×p₂<τ. From the histograms of FIGS. 6(c) and 7(c), it can be determined that a suitable value for the threshold is τ=0.2.

In comparison, if only p₁ was used and a threshold of about 0.07 to 0.08 was set, all or nearly all valid touch contacts would be correctly interpreted as touches, but some noise events would not be interpreted as noise. If only p₂ was used and a threshold of about 0.07 to 0.08 was set, all or nearly all noise events would be correctly interpreted as noise, but some touch contacts would not be interpreted as valid touches. By using a suitable formula that combines p₁ and p₂, occurrences of correct valid touch interpretations and correct noise event interpretations can each be increased.

In addition to distinguishing between signals from valid touch contacts and signals from acoustic noise events, the present invention may have application to sensing tracing movements over the panel. During tracing, the movement of the tracing implement (such as a stylus, pen or finger) on the panel generates a noise-like signal. Dispersion corrected correlation functions may be used to locate the position of the contact, for example using methods disclosed in WO2003005292, previously referred to and incorporated by reference. The spectral shape of the detected input will be related to the contact pressure, the velocity of the movements on the plate, the implement type, and so forth. As such, typical spectra may be correlated to known classes of movements, for example by comparing detected spectra against a table of characteristics of different movements, pressures, and contact implements that may be recorded during a calibration procedure.

Steady state acoustic noise can also be picked up by the panel and correctly interpreted as noise rather than as the presence of a moving contact. In some cases, however, steady state noise might be interpreted as a moving trace on the panel. The most commonly occurring spurious event is a reported touch moving around the central portion of the touch panel when no such movement is occurring. This can happen in typical operating environments where a sound far from the touch screen generates similar noise-like signals on each of the sensing channels, resulting in central correlation function peaks similar to what would result from a valid touch in the middle of the screen. If the noise source is close to the screen, then peaks indicative of a touch location under the contact can result as discussed above with respect to impulsive acoustic noise. In these circumstances, a measure based on the spectral shape of the pickup signals may help distinguish between a valid contact, whose spectral shape and trace characteristics fit a pre-determined template, and steady state acoustic noise, which has a different spectral shape than that of a typical finger or stylus contact traced on the panel with a tracing movement similar to what is exhibited by the spurious contact. As discussed above, the signals created by the noise event generally exhibit less low frequency content in its energy spectrum than for valid touches.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method comprising:
detecting vibrations propagating in a panel;
developing a signal representative of the vibrations;
generating an energy spectrum for the developed signal; and
analyzing the energy spectrum for the presence of one or more features characteristic of ambient noise.

2. The method of claim 1, wherein the ambient noise is acoustic noise.

3. The method of claim 1, further comprising discerning whether the vibrations were caused by a contact to the panel or an ambient acoustic noise event.

4. The method of claim 1, wherein the panel has a coincidence frequency, and the one or more features characteristic of ambient noise include a higher relative magnitude of above coincidence energy as compared to below coincidence energy.

5. The method of claim 1, further comprising reporting a valid panel contact when the one or more characteristic features are absent and reporting an ambient noise event when the one or more characteristic features are present.

6. The method of claim 5, wherein reporting a valid panel contact further comprises determining the contact location.

7. The method of claim 5, wherein reporting a valid panel contact further comprises determining the contact type.

8. The method of claim 5, wherein reporting an ambient noise event further comprises determining the ambient noise type.

9. The method of claim 1, wherein generating the energy spectrum for the developed signal comprises converting the developed signal from time domain to frequency domain.

10. The method of claim 1, wherein generating the energy spectrum for the developed signal comprises reconstructing an impulse from the developed signal, windowing around the reconstructed impulse to generate a filtered signal, and using the filtered signal to generate the energy spectrum.

11. The method of claim 1, further comprising analyzing the developed signals using an additional technique to discern ambient noise from valid panel contacts.

12. The method of claim 11, wherein the additional technique comprises impulse reconstruction.

13. The method of claim 11, wherein the additional technique comprises monitoring for ambient noise using an acoustically isolated microphone.

14. A method for use with a vibration sensitive touch panel comprising:
characterizing a first feature set for energy spectra associated with panel vibrations caused by valid panel contacts;
characterizing a second feature set different than the first for energy spectra associated with vibrations caused by noise; and
comparing signals obtained from measured panel vibrations to the first feature set and the second feature set to determine whether the measured panel vibrations are indicative of a valid panel contact or a noise event.

15. The method of claim 14, wherein the noise event is an ambient noise event.

16. The method of claim 14, wherein the noise event is a mechanical noise event.

17. A vibration sensing touch panel system comprising:
vibration sensors coupled to a touch plate, the vibration sensors configured to generate signals in response to vibrations propagating in the touch plate; and
electronics in communication with the vibration sensors and configured to analyze an energy spectrum of the signals generated by the vibration sensors to determine the presence or absence of spectral features indicative of acoustic noise.

18. The vibration sensing touch panel system of claim 17, further comprising a display viewable through the touch plate.

19. The vibration sensing touch panel system of claim 17, wherein the electronics are further configured to determine location of a touch contact to the touch plate in the absence of the spectral features indicative of acoustic noise.

20. The vibration sensing touch panel system of claim 17, wherein the spectral features indicative of acoustic noise include a ratio of total signal content over a first, high range of frequencies to total signal content over a second, low range of frequencies.
